(19) United States
(12) Patent Application Publication
(10) Pub. No.: US 2006/0251565 A1
(43) Pub. Date: Nov. 9, 2006

(54) Method for manufacturing the nanoporous skeletonC material

(75) Inventors: Jaan Leis, Tartu (EE); Mati Arulepp, Tartu (EE); Marko Latt, Tartu (EE); Helle Kuura, Tartu (EE); Andres Kuura, Tartu (EE)

Correspondence Address: BIRCH STEWART KOLASCH & BIRCH, PO BOX 747, FALLS CHURCH, VA, 22040-0747, US

(73) Assignee: TARTU TEHNOLOOGIAD OU

(21) Appl. No.: 11/407,202

(22) Filed: Apr. 20, 2006

Related U.S. Application Data
(60) Provisional application No. 60/673,788, filed on Apr. 22, 2005.

(51) Int. Cl. C01B 31/02

(52) U.S. Cl. 423/445 R

(57) ABSTRACT

A method to produce the nanostructured carbon material comprising the steps of synthesis of metal or metalloid oxide (STAGE B) from respective metal or metalloid chloride, synthesis of metal or metalloid carbide (STAGE C) from respective metal or metalloid oxide and synthesis of metal or metalloid chloride (STAGE D) from the solid product wherein the metal or metalloid carbide in STAGE C is synthesized from the respective metal or metalloid oxide produced in STAGE B.

### CROSS REFERENCE TO RELATED APPLICATIONS

This application claims the benefit under 35 USC 119(e) of U.S. provisional patent application 60/673,788 filed Apr. 22, 2005, the entire file wrapper contents of which are herein incorporated by reference as though fully set forth at length.

### FIELD OF THE INVENTION

This invention relates in general to the field of nanoporous carbon materials. More particularly, this invention relates to a manufacturing of low-cost carbide-derived carbon using environmentally beneficial closed cycle production line. A novel manufacturing scheme gives the opportunity to selectively control the nanopores content and pore size distribution in carbide-derived carbon.

### BACKGROUND OF THE RELATED ART

High-area activated carbon materials are widely used in a variety of industries. The vast majority of the activated carbon is prepared by the charring or carbonization of organic substances, usually followed by a surface activation process using water vapor or other solid, liquid or gaseous activation agents. Substantially different method to produce high-area nanoporous carbon is described in GB 971,943 and regards to the so-called mineral active carbon. The advantage of this kind carbon is that due to “the memory effect” it's nanostructure particularly follows the structure and the spacing of carbon atoms in the crystal lattice of precursor material. Most suitable mineral precursors are metal- or metalloid carbides, which can be used for the making of structurally finely tuned carbon materials as, for example, described in U.S. Pat. No. 6,602,742 and U.S. Pat. No. 6,697,249.

However, in spite of superior nanostructural characteristics the drawback of carbide-derived carbon is the relatively high manufacturing cost and substantial dependence on the availability and quality of precursor carbide. Consequently, the goal of present invention is to offer the solution to lower the cost of the nanostructured carbide-derived carbide and secondly, to enable the better control over the availability and quality of precursor carbide.

Present invention regards to the cyclic production process of carbide-derived carbon involving the general stages in following sequence: synthesis of oxide from respective halide; synthesis of respective carbide from oxide; and synthesis of carbide-derived carbon from carbide, whereby the respective halide by-produced is redirected to the synthesis of oxide.

For example, the preparation of pigmentary metal oxide, e.g., titanium dioxide, by vapor phase oxidation of metal halide, e.g., titanium tetrahalide, is described in U.S. Pat. No. 3,650,694. Another patent, GB1,482,173, describes the production of finely divided oxides by (a) reacting in a reaction chamber the corresponding chloride in the gas phase at high temperatures and super-ambient pressure with O₂ or O₂-containing gas, which has been heated in the chamber by burning a gaseous fuel (b) separating the finely divided solid oxide from the reaction gases using wet separation or effected in a filter and/or cyclone and (c) passing the reaction gases without further compression to a chlorination plant at a super-ambient pressure as at least part of the Cl₂ source material for forming said corresponding chloride by the reaction of chlorine with an oxide or oxidic material. It is obvious that the oxide or oxidic material can be the ore such as rutile. Suitable particle size of titanium oxide powder for the subsequent carbide synthesis according to this invention may vary in wide range, but most preferably being of approximately 1 to 5 micrometers.

Method of production of titanium carbide is described in GB748,808. It says that titanium carbide having a particle size of 1-50 microns is produced by heating an intimate mixture of hydrated titanium oxide and finely divided carbon, e.g. lamp black or oil burner soot, having a particle size of 0.01-0.5 microns at a temperature of 1350-1750° C. Intimate mixing is preferably effected by forming an aqueous slurry preferably in the presence of a surface active agent, e.g. polyethylene glycol or “Tergitol” penetrant (R.T.M.) or sulfuric or hydrochloric acid. The slurry is preferably dried to a cake, and the cake ground prior to calcining. However, the drying and calcining treatments may be combined when the desired product is obtained by a simple crushing operation without grinding. Sintering may be effected in an atmosphere of argon. Another patent, JP2,271,919, describes the production of fine powder of titanium carbide. 100 pts·wt. of TiO₂ powder of 0.1-5 μm average particle size, 0.05-30 pts·wt. of the additive TiO₂ of <=0.05 μm average particle size and amorphous carbon powder such as furnace black by 40-70 pts·wt. to the total TiO₂ are mixed together. This mixture is then dried, put in a graphite reactor and sintered in a non-oxidative atmosphere at 1300-1800° C. to produce fine powder of TiC. Yet another patent, U.S. Pat. No. 5,417,952, describes the process for synthesizing titanium carbide, titanium nitride or titanium carbonitride. The process comprises placing particles of titanium, a titanium salt or titanium dioxide within a vessel and providing a carbon-containing atmosphere within the vessel. The vessel is heated to a pyrolysis temperature sufficient to pyrolyze the carbon to thereby coat the particles with a carbon coating. Thereafter, the carbon-coated particles are heated in an inert atmosphere to produce titanium carbide, or in a nitrogen atmosphere to produce titanium nitride or titanium carbonitride, with the heating being of a temperature and time sufficient to produce a substantially complete solid solution.

Methods to make the carbide-derived SkeletonC carbon are described for example in parent documents WO2004/094307 and WO2005/118471.

The foregoing demonstrates that, separately, the stages required in environmentally friendly and cost-efficient cycled production line for carbide-derived carbon have been widely studied in the prior art. Yet with all of this study, there is still a great need for the development of connectivities and optimum conditions for the stages, all affecting each other, whereby finally determining the quality and properties of carbide-derived carbon.

### Definitions

For the purpose of this patent application, the terms nanoporous, nanoporosity and nanostructured apply to pore sizes less than 2 nanometers. Otherwise the IUPAC definitions are used to micro-, meso- and macropores. By the name “SkeletonC” is denoted a purified, dechlorinated carbide-derived carbon (CDC).

### SUMMARY OF THE INVENTION

In summary, an object of the present invention is to provide the economically beneficial production scheme for manufacturing the carbide-derived SkeletonC carbon, which nanostructure and pore size distribution can be tuned to meet the different adsorption-based applications.

In particular, the present invention provides the TiC-derived SkeletonC production method, which schematically is represented in FIG. 1. The method comprises of multi-stage production line containing four stages:

Stage A. Beneficiation of the ore (rutile) through the chlorination process as possible initial stage of the SkeletonC production line;

Stage B. Synthesis of titanium oxide (TiO₂) powder from TiCl₄;

Stage C. Synthesis of titanium carbide (TiC) powder using the high-temperature reduction of TiO₂ with carbon (charcoal, lampblack, etc.); and

Stage D. Synthesis of SkeletonC using the high-temperature chlorination of titanium carbide powder.

Noticeable economic benefit in production of SkeletonC is provided by the recycling of main reactants, minimized waste-consumption and flexible management with intermediate products. In fact, the intermediate products (TiCl₄, TiO₂, TiC) of the cyclic SkeletonC production line are valuable products used in chemical and ceramic industry or for producing the titanium sponge. Cyclic production technology (FIG. 1) yields minimum waste, because of the most titanium and chlorine are continuously recycled. To compensate the losses during production cycle, the additional amount of TiCl₄, e.g. produced from the ore according the Stage A, is introduced to the production line. However, it is obvious that adding the titanium oxide or carbide of required quality can also compensate the loss of Titanium.

This also allows, in another aspect of the present invention, the flexibility in changing the SkeletonC properties. TiO₂ quality and particle size can be controlled in Stage B that further affects the TiC outcome and quality in Stage C. Changing the TiC production conditions in Stage C allows varying the TiC quality that significantly influences the carbide chlorination conditions and final properties of SkeletonC in Stage D. Changing the TiC quality is achieved for instance by changing the added carbon quality, particle size or stoichiometries of reactants, or reaction time in Stage C. Tuning the reaction time in Stage C allows making the TiC/TiO₂ composites of predetermined ratios that is desirable for the final quality of certain SkeletonC materials. Fine-tuning of the nanostructure and pore size distribution of SkeletonC is realized by choosing the appropriate chlorination conditions such as temperature and additives in Stage D.

In another aspect of the present invention, a method is provided wherein nanostructured carbon is synthesized from inorganic polycrystalline material to selectively control the pore size and pore size distribution in the resulting carbonaceous material. SkeletonC, having large surface area, is generally a microporous carbon, which pore structure depends on the quality of precursor carbide and conditions of the carbide chlorination reaction. However, the nanostructure and pore size distribution of SkeletonC can be varied in wide range.

### BRIEF DESCRIPTION OF THE TABLES

TABLE 1 is a table, which summarizes titanium carbide examples made in Stage C according to this invention;

TABLE 2 is a table, which summarizes the SkeletonC examples of this invention synthesized in Stage D from titanium carbides noted in Table 1;

TABLE 3 is a table representing the comparison of EDLC parameters of different SkeletonC materials (Examples 1a-12a) of this invention measured in two-electrode cells filled with TEMA/AN electrolyte.

### BRIEF DESCRIPTION OF THE FIGURES

The patent or application file contains at least one drawing executed in color. Copies of this patent or patent application publication with color drawing(s) will be provided by the office upon request and payment of the necessary fee.

FIG. 1 is schematic drawing of the cyclic SkeletonC production line according to the invention;

FIG. 2 represents the XRD spectra of examples 2, 4 and 6 synthesized at 1600° C. in Stage C;

FIG. 3 represents the XRD spectra of examples 2, 7, 10, 13, 14, 15 using TiO₂/C mole ratio of 1/3 in Stage C;

FIG. 4 represents the XRD spectra of examples 3, 8, 11, 16, 17, 18 using TiO₂/C mole ratio of 1/2.7 in Stage C;

FIG. 5 represents the XRD spectra of SkeletonC examples according to this invention;

FIG. 6 represents the low-temperature N₂ adsorption isotherms for SkeletonC examples 1a-5a, while the carbide was synthesized at 1600° C. using different TiO₂/C mole ratios;

FIG. 7 represents the low-temperature N₂ adsorption isotherms for SkeletonC examples 10a-12a, while the carbide was synthesized at 1450° C. using different TiO₂/C mole ratios;

FIG. 8 represents the low-temperature N₂ adsorption isotherms for SkeletonC examples 2a, 7a, 10a, while the carbide was synthesized at different temperatures using TiO₂/C mole ratio of 1/3;

FIG. 9 represents the low-temperature N₂ adsorption-desorption isotherms for SkeletonC examples 3a, 8a, 11a while the carbide was synthesized at different temperatures using TiO₂/C mole ratio of 1/2.7;

FIG. 10 shows the relationship between porosity parameters of SkeletonC examples 1a-5a and the mole ratio of C/TiO₂, which had been used to synthesized the carbide at 1600° C. according to this invention;

FIG. 11 shows the relationship between porosity parameters of SkeletonC examples 7a-9a and the mole ratio of C/TiO₂, which had been used to synthesized the carbide at 1530° C. according to this invention;

FIG. 12 shows the relationship between porosity parameters of SkeletonC examples 10a-12a and the mole ratio of C/TiO₂, which had been used to synthesized the carbide at 1450° C. according to this invention;

FIG. 13 demonstrates the capacitance of SkeletonC materials of this invention;

FIG. 14 represents the relationship between the specific capacitance of SkeletonC materials of this invention and the apparent density of electrodes.

### DETAILED DESCRIPTION OF THE INVENTION

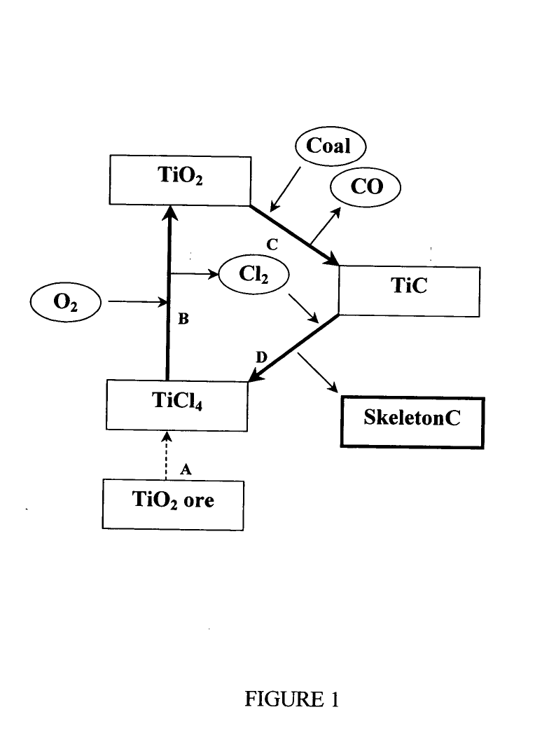

The invention will now be described in more detail with reference to exemplifying embodiments thereof and also with reference to the accompanying drawings of which FIG. 1 illustrates a general scheme of the closed cycle production of SkeletonC carbon.
Stage A. Beneficiation of the ore (rutile) through the chlorination process. Possible initial stage of the SkeletonC production line
   TiO₂+2C +2Cl₂→TiCl₄+2CO
Stage B. Synthesis of titanium oxide (TiO₂) powder from TiCl₄
   TiCl₄+O₂→TiO₂+2Cl₂
Stage C. Synthesis of titanium carbide (TiC) powder using the high-temperature reduction of TiO₂ with carbon (charcoal, lampblack, etc.)
   TiO₂+3C→TiC+2CO
Stage D. Synthesis of SkeletonC using the high-temperature chlorination of titanium carbide powder
   TiC+2Cl₂→C+TiCl₄

It was recently found that a small quantity of TiO₂ additive in the parent carbide could be useful for making the nanoporous TiC-derived carbon. WO 2005/118471 teaches the technique for preparation of SkeletonC possessing the outstanding sorption behavior. Before high-temperature chlorination an optimum quantity of TiO₂ pigment is mixed into the carbide powder. Evidently, it is possible that in cyclic multistage (A, B, C and D) SkeletonC production line of this invention, the mechanical mixing of TiO₂ before chlorination of carbide in Stage D can be substituted by the optimizing the reaction conditions of carbothermal reduction of the oxide in Stage C so that the intermediate carbide product would contain the desired amount of evenly distributed oxide additive.

On the other hand, it is known that the homogeneous nanoporous carbon is created by chlorination of TiC at temperatures below 900° C. [Carbon 40, 1559-64 (2002)]. Even more so, the lower is the chlorination temperature, the higher would be the homogeneity of nanoporous CDC. It is also known that chlorination of TiC at temperatures below 600-700° C. results in noticeably dense nanoporous carbon network. This kind of carbon is difficult to use in practice, because of the very slow mass-transport in nanopores. For example, the studies of supercapacitor electrode materials have confirmed that the optimum size distribution of nanopores for the effective sorption of the electrolyte ions is achieved by chlorination of TiC at approximately 800° C.

On the other hand, several studies have shown that the size and size-distribution of pores and cavities in CDC materials are directly related to the crystal structure of the parent carbide and the relative content of carbon in carbide crystal lattice. The lower is the relative concentration of carbon (i.e. the smaller is the stoichiometric constant x in chemical formula of carbide MCₓ), the larger would be pores and lower would be apparent density of respective CDC material.

Hypothetical reaction between carbon and titanium oxide would be described by the equation:
TiO₂+2C→TiC+CO₂

However, it is experimentally confirmed that in practice the temperature for the carbothermal reduction of TiO₂ must exceed 1000° C. More so, the thermodynamic studies show that formation of TiC in conditions of the carbothermal reduction of TiO₂ starts at temperatures above 1350° C. [J. Mat. Science 34, 3083-3093 (1999)]. It is also known that at temperatures above 1000° C. the Boudouard' equilibrium [J. Chem. Soc. Trans. 97, 2178-89 (1910)]:
C+CO₂→2CO
is strongly shifted to right side and therefore the mass-balance of TiC formation should be expressed by the following equation:
TiO₂+3C→TiC+2CO

What happens if less amount of carbon is involved in reaction? Depending on the particle size of reagents, the contact between solid reagents, homogeneity of the reaction mixture and the temperature of reaction medium two different pathways could be assumed:
TiO₂+(3−x)C→TiC₁₋ₓ₊2CO
TiO₂+(3−x)C→(1−x/3)TiC+x/3TiO₂+(2−2x/3)CO

It is very likely that in reality the product of carbothermal reduction of carbide is a mixture of these two equations. In other words, the solid product would contain both, the non-stoichiometric carbide and unreacted titanium oxide.

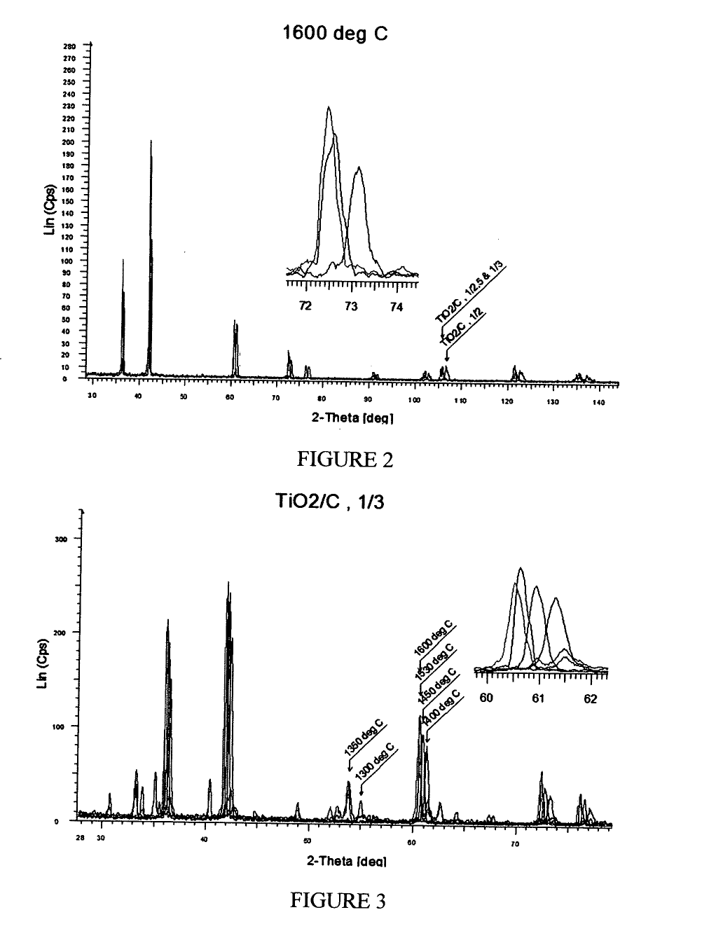

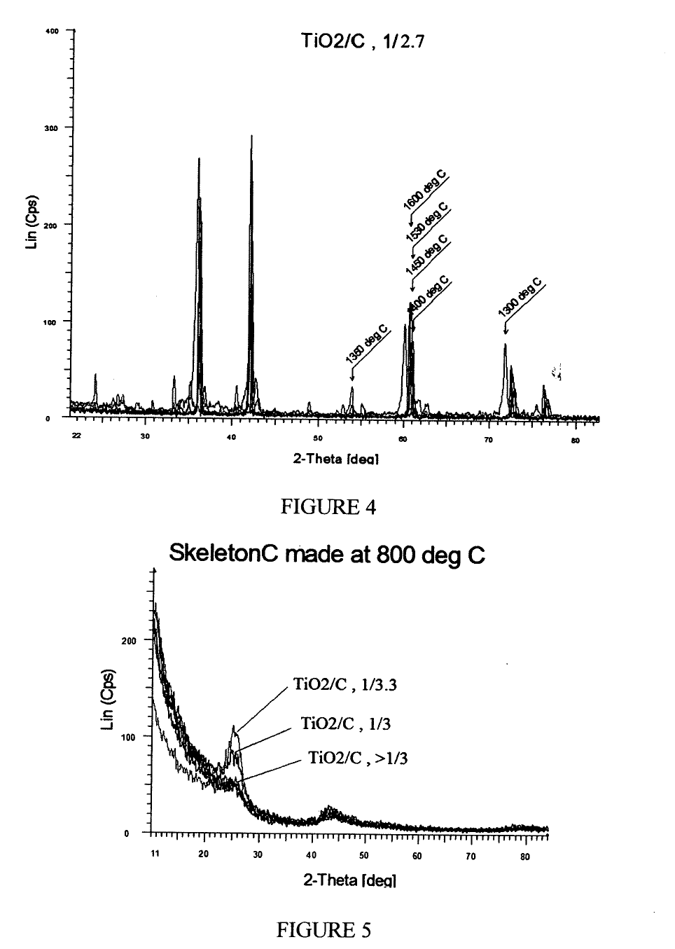

It is thus a further goal of this invention to find the methods and rules that enable control over the SkeletonC properties and performance through technological parameters of different stages of cyclic SkeletonC production line (cf. FIG. 1). The influence of reaction stoichiometry and temperature on the composition and quality of carbide-product in Stage C was studied by means of X-ray diffraction. FIG. 2 shows the effect of TiO₂/C ratio at synthesis temperature of 1600° C. According to the precision of XRD measurements no residual oxide was observed in product at all ratios of precursors. It was also revealed that noticeable decrease in stoichiometric constant x in TiCₓ takes place at the C/TiO₂ mole ratios of 2.5 and below. FIGS. 3 and 4 show the temperature effect on the carbide-product while the mole ratio of C/TiO₂ is 3.0 or 2.7, respectively. It was confirmed that below 1350° C. no carbide is formed from C/TiO₂ composite. Instead of carbide, the lower oxides of titanium were observed, while composition of oxides varied with synthesis temperature, thus in general being in good accordance with the findings of Koc et al. [J. Mat. Science 34, 3083-3093 (1999)].

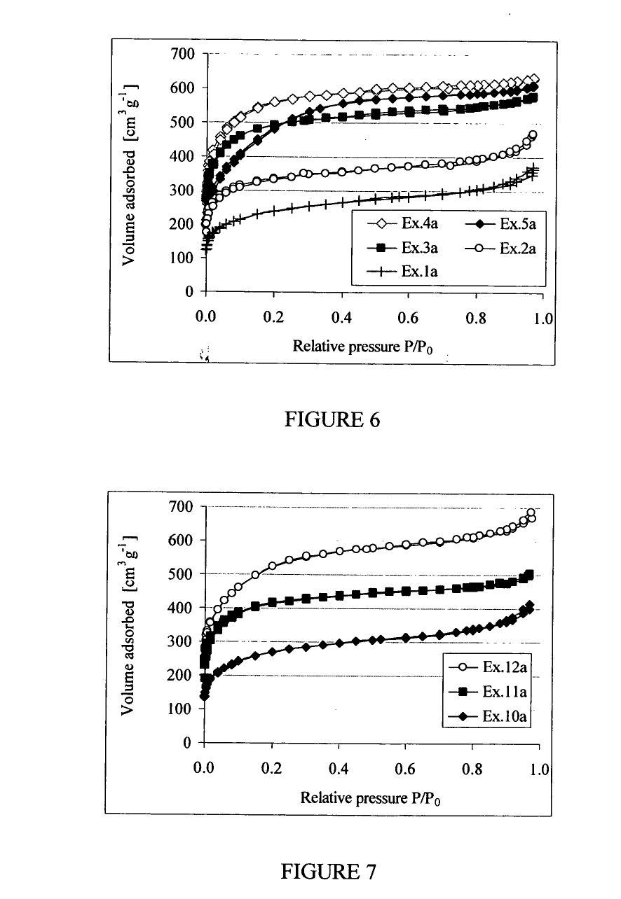

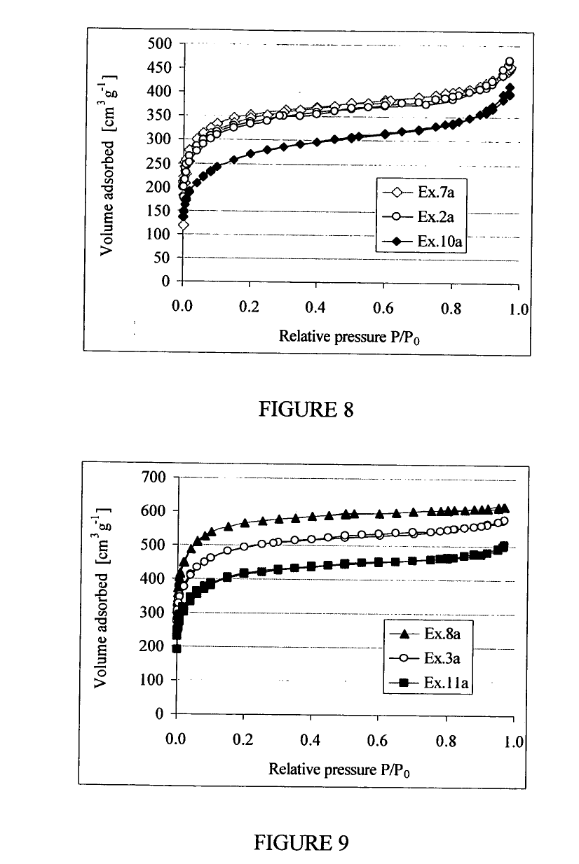

Studies of the XRD and adsorption properties of SkeletonC carbon made in Stage D from the products of Stage C reveal the noticeable relationships between the Stage C process parameters and the quality of SkeletonC. FIG. 5 confirms that neither oxide nor carbide was detected in SkeletonC XRD patterns. Further, it is also obvious that SkeletonC contains the guest-carbon, used in Stage C, if the carbide was made from TiO₂/C composite with the mole-ratio lower than 2.7. Low temperature nitrogen sorption isotherms in FIGS. 6-7 clearly show that the porosity of SkeletonC increases with decreasing ratio of C/TiO₂ in Stage C of carbide making. Sorption isotherms presented in FIGS. 8-9 confirm that there is an optimum carbide making temperature in Stage C (˜1500° C.) that produces the SkeletonC of highest porosity.

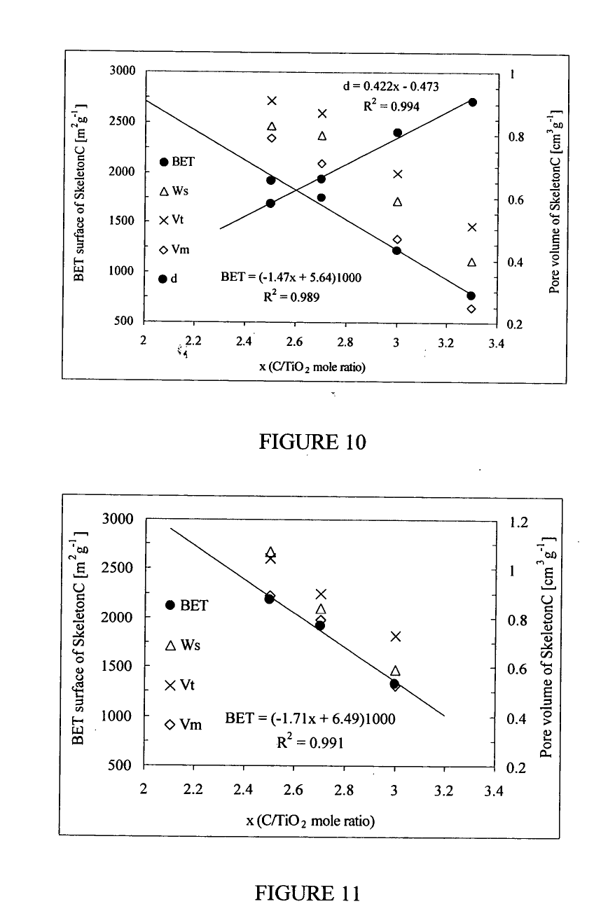

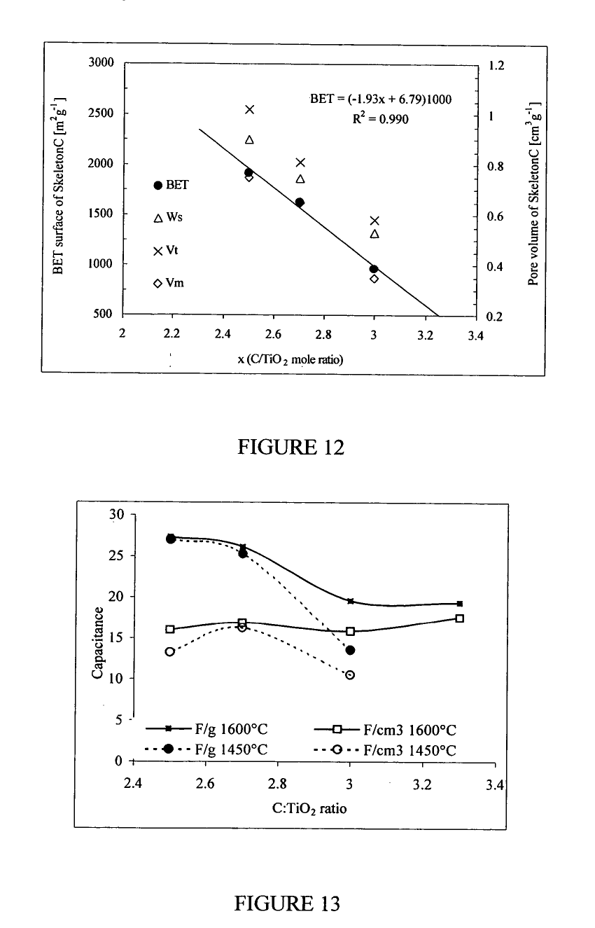

Finally, the quantitative relationships between Stage C parameters and SkeletonC properties were assumed as shown in FIGS. 10-12. The C/TiO₂ ratios between 2.5 and 3.3 in Stage C relate linearly to the several porosity characteristics, such as specific surface, total pore volume, benzene adsorption, apparent density, etc. of SkeletonC carbon chlorinated at ˜800° C. in Stage D.

If the carbide making temperature in Stage C is chosen 1600° C., the following equation describes the relationship between specific surface (BET) of SkeletonC and the C/TiO₂ ratio (x):
BET=(−1.47x+5.64)·1000, whereby the square of correlation coefficient R²=0.989.

If the carbide making temperature in Stage C is chosen e.g. 1530° C., the following equation describes the relationship between specific surface (BET) of SkeletonC and the C/TiO₂ ratio (x):
BET=(−1.71x+6.49)·1000, whereby the square of correlation coefficient R²=0.991.

If the carbide making temperature in Stage C is chosen e.g. 1450° C., the following equation describes the relationship between specific surface (BET) of SkeletonC and the C/TiO₂ ratio (x):
BET=(−1.93x+6.79)·1000, whereby the square of correlation coefficient R²=0.990.

It is thus another observation that the lower is temperature chosen to make carbide in Stage C, the stronger the specific surface of SkeletonC is influenced by C/TiO₂ mole ratio, i.e. the deeper is a slope of BET-x in FIGS. 10-12.

Observations of the study also confirmed that the C/TiO₂ mole ratios below 2.5 are not reasonable in practice, because the relative amount of carbon in TiCₓ crystal lattice would be too low to use such precursor material for SkeletonC production in Stage D. More so, it was confirmed that the yield of SkeletonC would be ˜0% if the C/TiO₂ mole ratio is close to 2.0.

Following examples describe the preparation of the carbide in Stage C.

### EXAMPLE 1

66.8 g of TiO₂ (Alfa Aesar, Ø˜1 μm) and 33.2 g of carbon powder (Alfa Aesar, Ø˜0.04 μm, S_{BET} 62 m²g⁻¹) are weighed leading to a mixture with a mole ratio of 1:3.3 and placed in a ball mill container with some milling media. The amount of milling media added is kept to a minimum since the goal is to dry mix the precursors and avoid the milling effect, which could affect the precontrolled particle size distribution of the precursor chemicals. The mill is run for 30 min on medium speed to create a uniform dry mixture of carbon and TiO₂. After that the milling media is separated and the mixture is transferred into the wet mixing container.

500 ml of chemical grade isopropanol is added to the dry mixture and gently stirred until viscous slurry is formed. After that the slurry is thoroughly stirred by means of an electric Laboratory Aid strirrer to ensure the best possible homogeneity of the mixture.

The homogenous wet mixture is transferred into a distillation flask to recover the solvent (isopropyl alcohol). The flask is brought to a temperature of 120° C. by means of an oil bath and kept at that temperature until no more solvent is coming off. After that the mixture is allowed to cool and then removed from the flask. The precursor is placed on a ceramic pan and kept at 200° C. for 120 min in an electric oven to remove the last traces of isopropyl alcohol. After the precursor is allowed to cool it's weighed (98 g of dry precursor mixture) and forwarded to the carbide synthesis reaction.

The carbide synthesis is carried out by heating the precursor mixture in an inert argon gas atmosphere at atmospheric pressure and at temperature reaching up to 1600° C. The process is performed in a graphite core reactor. Reactor temperature is controlled by a high temperature thermocouple and a digital thermocontroller.

98 g of the precursor mixture is weighed and placed in a graphite capsule. The capsule is placed into the center of the reactor core. The reactor is hermetically sealed, atmospheric air is pumped out of the reactor by a vacuum pump and the reactor is filled with argon gas (AGA Gas Ar S-quality). This procedure is repeated three times to replace all of the atmospheric air inside the reactors core with argon gas. The reactors vent valves are opened after the reactor is filled with argon gas and a steady flow of argon (1.0 dm³/min) is established through the reactor core. The gas flow is controlled by a rotameter.

The reactor is powered up and the core temperature reaches it's preset value of 1600° C. in 10 min. The reactor's core is kept at that temperature for 120 min. During that time the carbide formation reaction reaches it's full equilibrium and the reaction is assumed complete. The reactor is powered down but the argon flow is kept constant during the cooling of the reactor. After 4 hours the core has reached room temperature. The reactor is opened and the graphite capsule is removed from the core. The reaction product is collected, weighed (62 g of product) and forwarded to further XRD analysis and carbon synthesis process.

### EXAMPLES 2-6

Examples 2-6 are made by the same procedure as example 1 except the mole ratio of TiO₂/C was varied in range of 1:3 to 1:2 in accordance with data in Table 1.

### EXAMPLES 7-9

Examples 7-9 were made by the same procedure as described in examples 2-4 except the temperature of reactor was 1530° C. in accordance with data in Table 1.

### EXAMPLES 10-12

Examples 10-12 were made by the same procedure as described in examples 7-9 except the temperature of reactor was 1450° C. in accordance with data in Table 1.

### EXAMPLES 13-15

Examples 13-15 were made by the same procedure as described in example 10 except the example 13 was synthesized at 1400° C., example 14 at 1350° C. and example 15 at 1350° C. in accordance with data in Table 1.

### EXAMPLES 16-18

Examples 16-18 were made by the same procedure as described in examples 13-15 except the mole ratio of TiO₂/C was 1:2.7 in accordance with data in Table 1.

TABLE 1
Titanium carbide examples made in Stage C.

| | TiO₂ | Carbon | | |
|---|---|---|---|---|
| | powder | powder | Mole | |
| | Alfa | Alfa | Ratio | T |
| Example | ˜1 μm | <<1 μm | TiO₂/C | [° C.] |
| 1 | X | X | 1:3.3 | 1600 |
| 2 | X | X | 1:3 | 1600 |
| 3 | X | X | 1:2.7 | 1600 |
| 4 | X | X | 1:2.5 | 1600 |
| 5 | X | X | 1:2.2 | 1600 |
| 6 | X | X | 1:2 | 1600 |
| 7 | X | X | 1:3 | 1530 |
| 8 | X | X | 1:2.7 | 1530 |
| 9 | X | X | 1:2.5 | 1530 |
| 10 | X | X | 1:3 | 1450 |
| 11 | X | X | 1:2.7 | 1450 |
| 12 | X | X | 1:2.5 | 1450 |
| 13 | X | X | 1:3 | 1400 |
| 14 | X | X | 1:3 | 1350 |
| 15 | X | X | 1:3 | 1300 |
| 16 | X | X | 1:2.7 | 1400 |
| 17 | X | X | 1:2.7 | 1350 |
| 18 | X | X | 1:2.7 | 1300 |

Further examples describe the preparation of the SkeletonC in Stage D

### EXAMPLE 1a

A product of Example 1 (55 g of TiC powder) with an average particle size of ˜1 μm was loaded into the stationary bed quartz-tube reactor and reacted with a flow of chlorine gas (99.999% assay) for 3 h in a stationary bed reactor at 800° C. Flow rate of chlorine gas was 1.5 dm³/min. The by-product, TiCl₄, was led away by the stream of the excess chlorine and passed through the water-cooled condenser into the collector. After that the reactor was flushed with argon gas (0.5 dm³/min) at 1000° C. for 1 h to remove the excess of chlorine and residues of a gaseous by-products from carbon. During heating and cooling, the reactor was flushed with a slow stream (0.5 dm³/min) of argon. Resulting carbon powder (11.7 g) was thereafter treated with hydrogen gas at 800° C. for 2.5 h. During heating and cooling, the reactor was flushed with a slow stream of argon (0.3 dm³/min). Final yield of the carbon material was 11.4 g (103% from theoretical).

### EXAMPLE 2a-9a

Examples 2a-9a were made by the same procedure as described in example 1a except the precursor carbides were 2-9, respectively, in accordance with table 2.

TABLE 2
SkeletonC examples synthesized in Stage D from TiC noted in Table 1.

| | Yield | Ws | BET |
|---|---|---|---|
| Example | [%] | [cm³/g] | [m²/g] |
| 1a | 103 | 0.39 | 785 |
| 2a | 93 | 0.84 | 1229 |
| 3a | 66 | 1.54 | 1754 |
| 4a | 53 | 0.83 | 1920 |
| 5a | 12 | 0.85 | 1771 |
| 6a | ˜0 | N/A | N/A |
| 7a | 75 | 0.59 | 1337 |
| 8a | 61 | 0.84 | 1917 |
| 9a | 53 | 1.07 | 2184 |
| 10a | 74 | 0.52 | 966 |
| 11a | 57.5 | 0.74 | 1626 |
| 12a | 43 | 0.89 | 1922 |

Additionally, the SkeletonC materials of this invention were evaluated for the electrochemical double layer performance. For that purpose the carbon electrodes were made as follows.

The mixture of 90% (wt.) nanoporous carbon and 10% (wt.) polytetrafluoroethylene (PTFE, Aldrich, 60% suspension in water) was thoroughly mixed using small amount of ethanol as the mixing aid and after that gently pressed until a wet cake was formed. Thereupon ethanol was evaporated. The cake was then impregnated with heptane, shaped to a cylinder and extruded by rolling the body in the axial direction of the cylinder. This procedure was repeated until elastic properties appeared. Finally, heptane was removed at ˜75° C. and the extruded cake was rolled stepwise down to the thickness of 100±2 μm. After drying in vacuum at 170° C., the raw electrode sheets were plated from one side with a thin aluminum layer (3±1 μm), using the plasma activated physical vapor deposition method.

The electric double layer capacitors were assembled from the pair of carbon electrode discs (cf. Table 3) separated with an ion-permeable separator paper from Kodoshi Nippon. The geometric surface area of electrode was 2.27 cm². The test-cells were vacuumed at 90° C. for 24 h prior to impregnation with the electrolyte. The electrolyte used was 1.2 M triethylmethylammonium tetrafluoroborate (TEMA, Stella) in anhydrous acetonitrile (AN, Riedel-de Haën, H₂O<0.003%).

Before evaluation, the electric double layer capacitor (EDLC) cells were preconditioned at +60° C. during 48 hours that was needed to saturate the dense nanoporous electrode body by the electrolyte. Thereafter continuous galvanostatic cycling between 2.5 V and 1.25 V with the current I=100 mA was carried out, prior performing the further electrochemical studies.

According to data in Table 3 and FIG. 13, the highest gravimetric capacitance per single electrode (105-110F/g) was achieved for the samples 3a, 4a, 11a, 12a. It is important to note that all these carbon samples are made from the carbide, for which the TiO₂/C mole ratio was 1/2.7. If the carbon/TiO₂ mole ratio is higher than 2.7:1, the excess of nonporous carbon in the carbide powder increases and, consequently, the capacitance of respective carbon sample is lower.

TABLE 3
Comparison of EDLC parameters of different carbon electrodes
(Examples 1a-12a) measured in two-electrode cells filled with
TEMA/AN electrolyte.

| | | | |
|---|---|---|---|
| | | Electrode | |
| Carbon | T | density | Capacitance |

| example | [° C.] | [g cm⁻³] | [F cm⁻³] | [F g⁻¹] |
|---|---|---|---|---|
| 1a | 1600 | 0.913 | 17.6 | 19.4 |
| 2a | 1600 | 0.800 | 15.9 | 19.6 |
| 3a | 1600 | 0.647 | 16.9 | 26.2 |
| 4a | 1600 | 0.586 | 16.0 | 27.4 |
| 5a | 1600 | 0.650 | 12.3 | 18.8 |
| 7a | 1530 | 0.770 | 18.3 | 22.4 |
| 10a | 1450 | 0.778 | 10.6 | 13.6 |
| 11a | 1450 | 0.643 | 16.3 | 25.3 |
| 12a | 1450 | 0.491 | 13.3 | 27.0 |

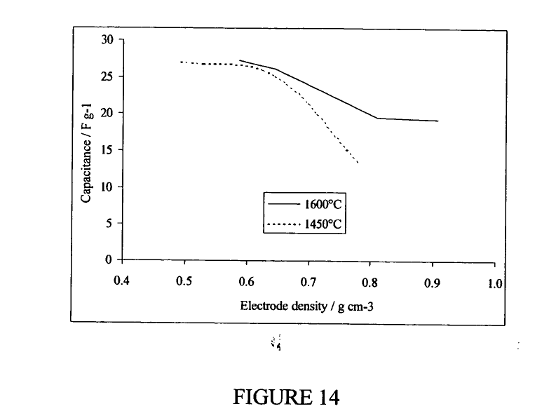

In FIG. 14 is pictured the capacitance vs. electrode density. As appears, the highest capacitance is achieved at the electrode density of ˜0.65 g cm⁻³. These values are in correspondence to those known from the prior art for the TiC derived SkeletonC materials synthesized at 800° C.

### Characterization of Nanostructured Carbon Materials According to this Invention

The low temperature nitrogen sorption experiments were performed at the boiling temperature of nitrogen (−196° C.) using Gemini Sorptometer 2375 (Micromeritics). The specific surface area of carbon materials was calculated according to Brunauer-Emmet-Teller (BET) theory up to the nitrogen relative pressure (p/p₀) of 0.2. The volume of micro-pores was calculated from the t-plot of adsorption isotherm and the pore size distribution according to Barrett-Joyner-Halenda (BJH) theory. The volume of nanopores was measured at room temperature using the computer controlled weighing of the carbon samples in benzene vapor at normal pressure and room temperature. A volume of nanopores was calculated according to the equation
Wₛ=(m₂−m₁)/m₁·d_{C}_{₆}_{H}_{₆} [cm³g⁻¹]
where m₁ and m₂ are the initial and final weights of the test-sample, respectively, and d_{C}_{₆}_{H}_{₆} is the density of benzene at room temperature.

Measurements of EDLCs in constant current charge/discharge regimes using voltage range ΔU from 1.25 V to 2.5 V were performed to evaluate the capacitance of carbon materials. The current I was varied from 10 mA to 500 mA. The discharge capacitance C, was calculated from the data of the tenths cycle according to

$$C = I \frac{Δ t}{Δ U}$$

at the current 30 mA. Δt is discharge time of EDLC.

In summary, the present invention provides the economically beneficial production scheme for manufacturing the SkeletonC carbon, which nanostructure and pore size distribution can be tuned to meet the different adsorption-based applications.

While the invention has been described with reference to certain preferred embodiments, numerous changes, alterations and modifications to the described embodiments are possible without departing from the spirit and scope of the invention as defined in the appended claims, and equivalents thereof.

1. A method to produce the nanostructured carbon material comprising the steps of
synthesis of metal or metalloid oxide (STAGE B) from respective metal or metalloid chloride,
synthesis of metal or metalloid carbide (STAGE C) from respective metal or metalloid oxide, and
synthesis of metal or metalloid chloride (STAGE D) from the solid product.

2. A method according to claim 1 wherein the metal or metalloid carbide in STAGE C is synthesized from the respective metal or metalloid oxide produced in STAGE B.

3. A method according to claim 1 wherein the metal or metalloid chloride in STAGE D is synthesized from the solid product produced in the STAGE C.

4. A method according to claim 1 wherein the nanostructured carbon is produced and separated in STAGE D and the physical parameters of nanostructured carbon are particularly controlled by the reaction conditions of STAGE C.

5. A method according to claim 1, wherein the chloride produced in STAGE D is redirected to STAGE B.

6. A method according to claim 1, wherein the main products synthesized in the STAGE B are the powder of metal or metalloid oxide and chlorine gas.

7. A method according to claim 1, wherein the chemical reaction in STAGE C is the carbothermal reduction of metal or metalloid oxide and the main product synthesized in the STAGE C is the powder of metal or metalloid carbide.

8. A method according to claim 7, wherein the reducing agent is carbon powder.

9. A method according to claims 1, wherein the metal or metalloid is titanium.

10. A method according to claim 9, wherein the mole ratio of TiO₂ and carbon in STAGE C is varied between 1:2 and 1:4, more preferably between 1:2.5 and 1:3.3.

11. A method according to claim 1, wherein the porosity characteristics of nanostructured carbon in STAGE D are related to the reaction conditions of STAGE C according to the equation Y=a X+b characterized with the square of the correlation constant R²>0.95, wherein Y may be specific surface area, the volume of pores, specific adsorption or similar characteristic of nanostructured carbon as a product of STAGE D and X is the mole ratio of carbon and TiO₂ in the beginning of carbothermal reduction of TiO₂ in STAGE C.

12. A method to produce the nanostructured carbon material comprising the steps of:
synthesis of metal or metalloid carbide (STAGE C) from respective metal or metalloid chloride, and
synthesis of metal or metalloid chloride (STAGE D) from the solid product in the STAGE C.

13. A method to produce the nanostructured carbon material according to claim 12, wherein the nanostructured carbon is produced and separated in STAGE D and the physical parameters of nanostructured carbon are particularly controlled by the reaction conditions of STAGE C.

14. A method according to claim 12, wherein the chemical reaction in STAGE C is the carbothermal reduction of metal or metalloid oxide and the main products synthesized in the STAGE C is the powder of metal or metalloid carbide.

15. A method according to claim 14, wherein the reducing agent is carbon powder.

16. A method according to claim 12, wherein the metal or metalloid is titanium.

17. A method according to claim 16, wherein the mole ratio of TiO₂ and carbon in STAGE C is varied between 1:2 and 1:4, more preferably between 1:2.5 and 1:3.3.

18. A method according to claim 12, wherein the porosity characteristics of nanostructured carbon in STAGE D are related to the reaction conditions of STAGE C according to the equation Y=a X+b characterized with the square of the correlation constant R²>0.95, wherein Y may be specific surface area, the volume of pores, specific adsorption or similar characteristic of nanostructured carbon as a product of STAGE D and X is the mole ratio of carbon and TiO₂ in the beginning of carbothermal reduction of TiO₂ in STAGE C.
